(19) United States
(12) Patent Application Publication
(10) Pub. No.: US 2019/0276348 A1
(43) Pub. Date: Sep. 12, 2019

(54) METHOD AND SYSTEM FOR REDUCING GLASS FAILURES FROM NICKEL SULFIDE BASED INCLUSIONS

(71) Applicant: GUARDIAN GLASS, LLC, Auburn Hills, MI (US)

(72) Inventors: Alexey KRASNOV, Canton, MI (US); Gregory T. GAUDET, Auburn Hills, MI (US); Xuequn HU, Northville, MI (US)

(73) Assignee: GUARDIAN GLASS, LLC, Auburn Hills, MI (US)

(21) Appl. No.: 16/295,099

(22) Filed: Mar. 7, 2019

Related U.S. Application Data
(60) Provisional application No. 62/639,566, filed on Mar. 7, 2018.

(51) Int. Cl. C03B 27/044; C03B 27/012; C03C 3/087

(52) U.S. Cl. CPC C03B 27/044; C03C 3/087; C03B 27/012

(57) ABSTRACT

A method and/or system for reducing glass failures following tempering from inclusions, such as nickel sulfide based inclusions. During at least part of a cooling down period of a thermal tempering process, additional energy is directed at inclusion(s), such as nickel sulfide based inclusion(s), in the glass. The glass may be soda-lime-silica based float glass. The additional energy may be in the form of, for example, visible and/or infrared (IR) light from at least one light source that is directed toward the nickel sulfide based inclusion(s).

### CROSS REFERENCE TO RELATED CASES

This application claims priority on U.S. Provisional Application No. 62/639,566, filed Mar. 7, 2018, the disclosure of which is hereby incorporated herein by reference.

### FIELD

Example embodiments of this invention relate to a method and/or system for reducing glass failures following tempering from inclusions such as nickel sulfide based inclusions. Methods and/or systems herein may be used with respect to glass, such as soda-lime-silica based float glass, in which such inclusions tend to occur. In certain example embodiments of this invention, during at least part of a cooling down period of a thermal tempering process, additional energy is directed at inclusion(s) such as nickel sulfide based inclusion(s) in the glass. The additional energy may be in the form of, for example, visible and/or infrared (IR) light from at least one light source that is directed toward the nickel sulfide based inclusion(s). It has been found that the additional energy directed at the inclusion(s) during at least part of the cool-down part of a thermal tempering process reduces the chances of the inclusion(s) being trapped in the alpha phase, and allows the inclusions to relax to their relatively harmless beta phase.

### BACKGROUND OF THE INVENTION

The process of making float glass is known in the art. For example, see U.S. Pat. Nos. 3,954,432, 3,083,551, 3,220,816, 7,743,630, 8,677,782, 9,016,094, and 5,214,008, the disclosures of all of which are hereby incorporated herein in their entireties by reference. Generally speaking, in a float glass-making line, batch materials are heated in a furnace or melter to form a glass melt. The glass melt is poured onto a bath of molten material such as tin (tin bath) and is then continuously cooled to form a float glass ribbon. The float glass ribbon is then forwarded to an annealing lehr for further processing and then may be cut to form solid glass articles, such as flat glass sheets. For float glass, the glass batch often includes soda, lime and silica to form soda-lime-silica based flat glass.

Float glass is widely used for windows in commercial and residential buildings, glass furniture, shower doors, and automotive windshields. For many products, float glass must be thermally tempered (undergo heating to at least 580 degrees C., followed by a rapid cooling) to ensure safety in case of breakage. Impurities from raw materials, sulfur from additive(s), and/or contaminations from the float process occasionally and unpredictably form unwanted chemical compounds (e.g., inclusions) during glass formation, which are undesirable defects in the glass. Nickel, for example, is known to spontaneously bond with sulfur to form inclusions of or based on nickel sulfide (of any suitable stoichiometry such as NiS).

Although typically harmless in annealed glass (e.g., made via the float process without any additional heat treatment such as thermal tempering), nickel sulfide inclusions are known for causing spontaneous breakage of thermally tempered glass. Moreover, nickel sulfide inclusions/defects in thermally tempered glass have caused catastrophic glass failure over long periods of time in installed products.

Various methods have been used for inline detection of NiS inclusions and other micro-defects of similar size scale (e.g., 40-150 microns sized defects). U.S. Pat. No. 7,511,807, incorporated herein by reference, for example directs light at the glass and looks for light scattering in order to detect inclusions.

It will be appreciated that there exists a need in the art to reduce such glass failures.

### SUMMARY OF EXAMPLE EMBODIMENTS OF THE INVENTION

Example embodiments of this invention relates to a method and/or system for reducing glass failures following tempering from inclusions such as nickel sulfide based inclusions. Methods and/or systems herein may be used with respect to glass, such as soda-lime-silica based float glass, in which such inclusions tend to occur. In certain example embodiments of this invention, during at least part of a cooling down period of a thermal tempering process, additional energy is directed at inclusion(s) such as nickel sulfide based inclusion(s) in the glass. The additional energy may be in the form of, for example, visible and/or infrared (IR) light from at least one light source that is directed toward the nickel sulfide based inclusion(s). The additional energy, in certain example embodiments, may be directed at the inclusion(s) through a window (e.g., quartz window) provided in a wall of a tempering chamber, so that the light source(s) may optionally be located outside the tempering chamber. It has been found that the additional energy directed at the inclusion(s) during at least part of the cool-down part of a thermal tempering process reduces the chances of the inclusion(s) being trapped in the alpha-phase, and allows the inclusions to relax to their relatively harmless beta-phase.

In an example embodiment of this invention, there is provided a method of thermally tempering glass in order to reduce glass failures from nickel sulfide based inclusions, the method comprising: thermally tempering glass including a base glass composition comprising: SiO₂ 67-75%, Na₂O 10-20%, CaO 5-15%, Al₂O₃ 0-7%, and K₂O 0-7%, wherein the thermally tempering comprises heating the glass to at least a softening temperature via temperature(s) of at least 580 degrees C., and then rapidly cooling the glass via forced cold air; and during at least part of the rapidly cooling, directing additional energy at a nickel sulfide based inclusion in the glass in order to slow down cooling of the inclusion, relative to another area of the glass, so as to allow the nickel sulfide based inclusion to transition safely from a high temperature alpha-phase to a beta-phase.

In an example embodiment of this invention, there is provided a system for thermally tempering glass in order to reduce glass failures from nickel sulfide based inclusions, the system comprising: a chamber configured for thermally tempering glass; at least one heat source (e.g., IR source(s)) configured to heat the glass in the chamber to at least a softening temperature via temperature(s) of at least 580 degrees C., at least one cooling port (e.g., one or more cooling jets) configured for rapidly cooling the glass via forced cold air; and at least one processor configured to, during at least part of the rapidly cooling, control at least one energy source to direct additional energy at a nickel sulfide based inclusion in the glass in order to slow down cooling of the inclusion, relative to another area of the glass, so as to allow the nickel sulfide based inclusion to transition safely from a high temperature alpha-phase to a beta-phase.

A system for processing glass in order to reduce glass failures from nickel sulfide based inclusions, the system comprising: a chamber configured for heating glass including a base glass composition comprising: SiO₂ 67-75%, Na₂O 10-20%, CaO 5-15%, Al₂O₃ 0-7%, and K₂O 0-7%; at least one heat source configured to heat the glass in the chamber to at least a softening temperature via temperature(s) of at least 580 degrees C., at least one cooling port configured for cooling the glass; and at least one processor configured to, during at least part of the cooling, control at least one energy source to direct additional energy toward the glass in order to slow down cooling of an inclusion, relative to another area of the glass, so as to allow the inclusion to transition safely from a first phase to a second phase.

### BRIEF DESCRIPTION OF THE DRAWINGS

FIG. 1 is a temperature (degrees C.) vs. time (seconds) graph illustrating a process according to an example embodiment of this invention where additional energy is directed at inclusion(s) in glass during at least part of a cooling down portion of a thermal tempering process.

FIG. 2 is a schematic diagram of a tempering system/apparatus for reducing glass failures from inclusions such as nickel sulfide based inclusions according to an example embodiment of this invention, which system/apparatus may utilize the procedure shown in FIG. 1.

### DETAILED DESCRIPTION OF CERTAIN EXAMPLE EMBODIMENTS OF THIS INVENTION

Example embodiments of this invention relates to a method and/or system for reducing glass failures following tempering from inclusions such as nickel sulfide based inclusions (e.g., nickel sulfide inclusions and/or other micro-defects, having a size of from about 30-200 μm, more preferably from about 40-150 μm). Methods and/or systems herein may be used with respect to glass, such as soda-lime-silica based float glass, in which such inclusions tend to occur. In certain example embodiments of this invention, during at least part of a cooling down period of a thermal tempering process, additional energy is directed at inclusion(s) such as nickel sulfide based inclusion(s) in the glass. The additional energy may be in the form of, for example, visible and/or infrared (IR) light from at least one light source that is directed toward the nickel sulfide based inclusion(s). The additional energy, in certain example embodiments, may be directed at the inclusion(s) through a window (e.g., quartz window) provided in a wall of a tempering chamber, so that the light source(s) may optionally be located outside the tempering chamber. The chamber may be a furnace, oven, and/or the like, and at least one heat source (e.g., IR source) may be located in the chamber for heating the glass for tempering as discussed herein. It has been found that the additional energy directed at the inclusion(s) during at least part of the cool-down part of a thermal tempering process reduces the chances of the inclusion(s) being trapped in the alpha-phase, and allows the inclusions to relax to their relatively harmless beta-phase.

Nickel sulfide exists in different phases at different temperatures. For instance, two specific phases of NiS known are the alpha-phase and the beta-phase. At temperatures below 715 degrees F. (379 C), nickel sulfide is relatively stable in the beta-phase form. Above this temperature, it is stable in the alpha-phase. Therefore, when glass is produced in a high temperature furnace, it is likely that any NiS inclusions will be in the alpha-phase. In typical annealed glass, the slow cooling process provided by the annealing lehr allows the NiS ample time to transform from its alpha-phase to its relatively harmless beta-phase as the glass cools.

However, glass (e.g., soda-lime-silica based float glass) is then often heat treated (HT), such as undergoing thermal tempering, for safety purposes. A typical thermal tempering process involves heating the glass using temperature(s) of at least 580 degrees C. (e.g., from about 580-640 degrees C., more preferably from about 580-620 degrees C.), and then rapidly cooling the glass via forced cold air. In the rapid/fast cooling process used for producing both heat-strengthened and tempered glass, there is often insufficient time for nickel sulfide based inclusions to complete a phase transition (which is a relatively slow process) from the troublesome alpha-phase to the relatively harmless beta-phase. The nickel sulfide inclusions are thus often trapped in the glass in their high-temperature alpha-phase, in thermally tempered glass for instance. However, once the glass cools past the phase change temperature, such a nickel sulfide inclusion seeks to reenter the lower energy beta-phase. For trapped inclusions, this process takes anywhere from months to years. This may have no effect on glass, were it not for the point that when the NiS changes from alpha-phase to beta-phase, it increases in volume such as by 2-4%. This expansion may create localized tensile stresses which can lead to glass failures. Thus, nickel sulfide based inclusions which are trapped in heat treated (e.g., thermally tempered) glass in their alpha-phase are problematic and can lead to subsequent failures of the glass.

Nickel sulfide is a compound that comes in various forms. The most common forms of nickel sulfide are Ni₇S₆, NiS, NiS_{1.03}, Ni₃S₂ and Ni₃S₂+Ni. When viewed under an electron microscope, Ni₇S₆, NiS, and NiS_{1.03} are yellow-gold in color and have a rugged surface similar to a golf ball. These three types are non-magnetic and have been found to cause failure in tempered glass, as discussed above.

In certain example embodiments, the soda-lime-silica based glass comprises a base glass portion that includes, by weight percentage: SiO₂ 67-75%, Na₂O 10-20%, CaO 5-15%, Al₂O₃ 0-7%, MgO 0-7%, and K₂O 0-7%. Optionally, a colorant portion of the glass may further include one or more colorants such as iron, selenium, cobalt, erbium and/or the like. Alternatively, the glass may be a different type of glass such as borosilicate glass, aluminosilicate glass, or the like.

An example soda-lime-silica base glass according to certain embodiments of this invention that may be made via the float process or other suitable process, on a weight percentage basis, includes the following basic ingredients:

TABLE 1
Example Base Glass

| Ingredient | Wt. % |
|---|---|
| SiO₂ | 67-75% |
| Na₂O | 10-20% |
| CaO | 5-15% |
| MgO | 0-7% |
| A1₂O₃ | 0-7% |
| K₂O | 0-7% |

Other minor ingredients, including various refining aids, such as salt cake, crystalline water and/or the like may also be included in the base glass. In certain embodiments, for example, glass herein may be made from batch raw materials silica sand, soda ash, dolomite, limestone, with the use of salt cake (SO₃) as a refining agent. Reducing and oxidizing agent(s) may also be used in certain instances. In certain instances, soda-lime-silica base glasses herein may include by weight from about 10-15% Na₂O and from about 6-12% CaO. In addition to the base glass materials discussed above, the glass batch and/or final glass may also include a colorant portion including material(s) such as iron, erbium, cobalt, selenium and/or the like in suitable amounts in order to provide coloration and/or absorption to the glass in a desired manner. In certain example embodiments of this invention, the amount of total iron in the glass may be from about 0.05 to 1.2%, more preferably from about 0.3 to 0.8%. In the case of certain clear high transmission glasses, the total iron may be from about 0.005 to 0.025%. The total amount of iron present in the glass, and thus in the colorant portion thereof, is expressed herein in terms of Fe₂O₃ in accordance with standard practice. This, however, does not imply that all iron is actually in the form of Fe₂O₃. Likewise, the amount of iron in the ferrous state is reported herein as FeO, even though all ferrous state iron in the glass may not be in the form of FeO.

When making the glass via the float process for example, the glass batch raw materials (e.g., silica sand, soda ash, dolomite, limestone, colorant(s), etc.) are provided in and heated in a furnace or melter to form a glass melt. The glass melt is poured onto a bath of molten material such as tin (tin bath), where the glass is formed and continuously cooled to form a float glass ribbon. The float glass ribbon proceeds toward an annealing lehr for slow cooling. Optionally, prior to entering the annealing lehr, lateral edge portion(s) of the glass sheet may be trimmed in a hot condition. The glass sheet typically reaches the beginning of the annealing lehr at a temperature of at least about 540 degrees C., more preferably at least about 580 degrees, C, with a possible range from about 540 (or 580) to 800 degrees C. During the annealing, the temperature of the glass sheet strip is slowly cooled from the annealing point (e.g., from about 538-560 degrees C.) to a strain point of from about 495-560 degrees C., which may be referred to as an annealing range. While these temperature ranges are preferred for annealing, different temperatures may be used in certain instances. The continuous glass sheet may be supported by either rollers or gas during annealing. After annealing, the continuous glass sheet is moved on for further processing such as one or more of cutting, additional cooling, coating and/or the like. On the float line, or following the float line, there may be provided a system for detecting inclusions (e.g., nickel sulfide based inclusions) in the glass. The inclusions may be detected, for example, via thermal imaging, wavelength analysis, naked eye analysis, imaging analysis, and/or light scattering analysis, for example. Such annealed glass may be used as is (e.g., in windows or other suitable applications), or alternatively may subsequently be heat treated (e.g., thermally tempered) for safety applications. The additional energy discussed herein that is directed toward the glass may in certain example embodiments be directed indiscriminately directly at the entirety or across substantially the entirety of the glass, when we do not know the exact location of any possible nickel sulfide based inclusion, or even any such inclusion(s) is/are present in the glass. However, in other example embodiments, when the presence and location of nickel sulfide based inclusions are known, the additional energy may be directed only at locations in the glass where nickel sulfide based inclusions are known to be present.

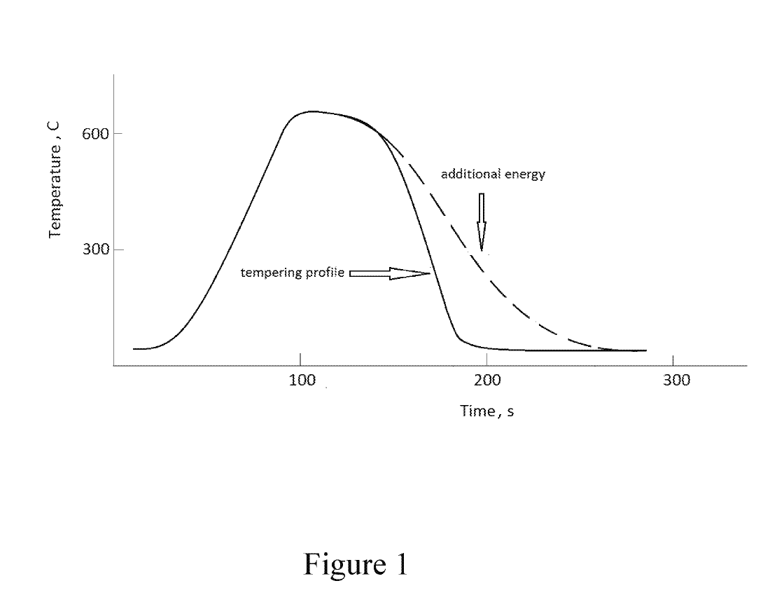

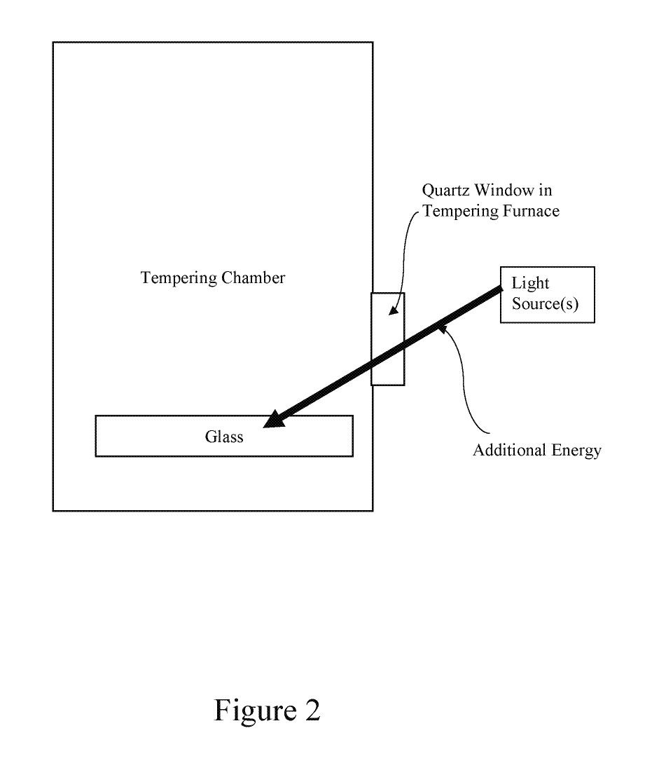

FIG. 1 is a temperature (degrees C.) vs. time (seconds) graph illustrating a process according to an example embodiment of this invention where additional energy is directed at inclusion(s) in glass during at least part of a cooling down portion of a thermal tempering process; and FIG. 2 is a schematic diagram of a tempering system/apparatus for reducing glass failures from inclusions such as nickel sulfide based inclusions according to an example embodiment of this invention, which system/apparatus may utilize the procedure shown in FIG. 1.

The thermal tempering process involves heating the glass to a softening temperature using temperature(s) of at least 580 degrees C. (e.g., from about 580-640 degrees C., more preferably from about 585-625 degrees C.), and then rapidly cooling the glass via forced cold air, as shown in FIG. 1. The glass is heated for about 0.5 to 10 minutes, more preferably from about 1-8 minutes. The glass is then rapidly cooled via forced cold air from nozzles or the like, and the temperature of the glass drops (e.g., see FIG. 1). However, the temperature drop is so steep as shown by the solid line in FIG. 1, there is often insufficient time for nickel sulfide based inclusions in the glass to complete a phase transition (which is a relatively slow process) from the troublesome alpha-phase to the relatively harmless beta-phase. The nickel sulfide inclusions are thus often trapped in the glass in their high-temperature alpha-phase, in thermally tempered glass for instance.

Referring to FIGS. 1-2, this problem is addressed by, during at least part of the cooling down period of the thermal tempering process, directing additional energy at inclusion(s) such as nickel sulfide based inclusion(s) in the glass in order to slow down the cooling process of the inclusions (e.g., see the dotted line in FIG. 1). The heating profile, cooling, and additional energy may be controlled by at least one processor configured for controlling the same, such as in the manner shown in FIG. 1 or otherwise described herein. In certain example embodiments of this invention, the additional energy is not directed at the entirety of the glass, but instead is directed only at area(s) of the glass having inclusion(s) (e.g., nickel sulfide based inclusions), so as to not significantly disturb the tempering process for the remainder of the glass, and so as to slow down the cooling process of the inclusion(s) relative to the cooling of the bulk of the glass being tempered. However, the additional energy may be applied to the entire glass substrate in alternative example embodiments of this invention. The additional energy may be in the form of, for example, visible and/or infrared (IR) light from at least one light source that is directed toward the nickel sulfide based inclusion(s). The light source(s) may be a laser, high intensity light source, or the like, and in certain example embodiments the additional energy may be focused on the area including the inclusion. The additional energy may comprise at least one wavelength in the range of from about 300 to 1100 nm, more preferably from about 380 to 700 nm, in certain example embodiments of this invention. The additional energy may be a single wavelength or just a few wavelengths, or may be a combination of various wavelengths in the specified wavelength range.

The additional energy, in certain example embodiments, may be directed at the inclusion(s) through one or more windows (e.g., at least one quartz window) provided in a wall of a tempering chamber, so that the light source(s) may optionally be located outside the tempering chamber. The window(s) through which the additional energy is/are directed may be provided in a sidewall(s) and/or ceiling of the tempering chamber in example embodiments of this invention. It has been found that the additional energy directed at the inclusion(s) during at least part of the cool-down part of a thermal tempering process slows down the cooling process for nickel sulfide based inclusion(s) and thus reduces the chances of the inclusion(s) being trapped in the alpha-phase, and thus allows the inclusions to relax to their relatively harmless beta-phase. The additional energy is provided in an amount sufficient to (i) prevent at least one nickel sulfide based inclusion in the glass from being trapped in the alpha-phase, and (ii) allow the nickel sulfide based inclusion in the alpha-phase to relax to the relatively harmless beta-phase within 24 hours of the end of the application of forced cold air, so that the inclusion in the final glass product is in the beta-phase.

In an example embodiment, as shown in FIG. 1, the additional energy is applied from a point close to the beginning of the cooling period and may continue until a point just prior to, at, or after the end of glass tempering. As a result, the sheet of glass gets tempered, and the nickel sulfide based inclusions are allowed to transition safely from their high-temperature alpha-phase to the relatively harmless beta-phase.

Accordingly, in an example embodiment of this invention, there is provided a method of thermally tempering glass in order to reduce glass failures from nickel sulfide based inclusions, the method comprising: thermally tempering glass including a base glass composition comprising: SiO₂ 67-75%, Na₂O 10-20%, CaO 5-15%, Al₂O₃ 0-7%, and K₂O 0-7%, wherein the thermally tempering comprises heating the glass to at least a softening temperature via temperature(s) of at least 580 degrees C., and then rapidly cooling the glass via forced cold air; and during at least part of the rapidly cooling, directing additional energy toward at least a nickel sulfide based inclusion in the glass in order to slow down cooling of the inclusion, relative to another area of the glass, so as to allow the nickel sulfide based inclusion to transition safely from a high temperature alpha-phase to a beta-phase.

In the method of the immediately preceding paragraph, the additional energy may be directed from at least one light source, toward the nickel sulfide based inclusion in the glass, through at least one window in a tempering chamber in which the glass is thermally tempered. The at least one window may comprise at least one quartz window.

In the method of any of the preceding two paragraphs, there may be provided focusing the additional energy on an area of the glass including the nickel sulfide based inclusion.

In the method of any of the preceding three paragraphs, the additional energy may comprise at least one wavelength in a range of from 300-1100 nm, more preferably from 380-700 nm. The additional energy may comprise a plurality of wavelengths in the range(s).

In the method of any of the preceding four paragraphs, the additional energy may be directed at the inclusion during at least a majority of the rapidly cooling process.

In the method of any of the preceding five paragraphs, the additional energy may be provided in an amount sufficient to: (i) prevent at least one nickel sulfide based inclusion in the glass from being trapped in the alpha-phase, and (ii) allow the nickel sulfide based inclusion in the alpha-phase to relax to the relatively harmless beta-phase within 24 hours of the end of the application of forced cold air, so that the inclusion in the final glass product is in the beta-phase.

In the method of any of the preceding six paragraphs, (a) the additional energy may be indiscriminately directed across the entirety, or across substantially the entirety (e.g., across at least 80% of a dimension of the glass), of a dimension of the glass, such as when location(s) of nickel sulfide inclusion(s) is/are not known and/or it is not known whether nickel sulfide based inclusion(s) is/are even present in the glass; or (b) the additional energy may be directed only at locations in the glass where nickel sulfide based inclusions are known to be present, such as in embodiments and/or situations where the presence and location of nickel sulfide based inclusions are known.

In an example embodiment of this invention, there is provided a system for thermally tempering glass in order to reduce glass failures from nickel sulfide based inclusions, the system comprising: a chamber configured for thermally tempering glass including a base glass composition comprising: SiO₂ 67-75%, Na₂O 10-20%, CaO 5-15%, Al₂O₃ 0-7%, and K₂O 0-7%; at least one heat source (e.g., IR source(s)) configured to heat the glass in the chamber to at least a softening temperature via temperature(s) of at least 580 degrees C., at least one cooling port (e.g., one or more cooling jets) configured for rapidly cooling the glass via forced cold air; and at least one processor configured to, during at least part of the rapidly cooling, control at least one energy source to direct additional energy at a nickel sulfide based inclusion in the glass in order to slow down cooling of the inclusion, relative to another area of the glass, so as to allow the nickel sulfide based inclusion to transition safely from a high temperature alpha-phase to a beta-phase.

Once given the above disclosure many other features, modifications and improvements will become apparent to the skilled artisan. Such features, modifications and improvements are therefore considered to be a part of this invention, the scope of which is to be determined by the following claims:

What is claimed is:

1. A method of thermally tempering glass in order to reduce glass failures from nickel sulfide based inclusions, the method comprising:
thermally tempering glass including a base glass composition comprising:

| Ingredient | wt. % |
|---|---|
| SiO₂ | 67-75% |
| Na₂O | 10-20% |
| CaO | 5-15% |
| A1₂O₃ | 0-7% |
| K₂O | 0-7% |

wherein the thermally tempering comprises heating the glass to at least a softening temperature via temperature(s) of at least 580 degrees C., and then rapidly cooling the glass via forced cold air; and
during at least part of the rapidly cooling, directing additional energy toward at least a nickel sulfide based inclusion in the glass in order to slow down cooling of the inclusion, relative to another area of the glass, so as to allow the nickel sulfide based inclusion to transition safely from a high temperature alpha-phase to a beta-phase.

2. The method of claim 1, wherein the additional energy is directed from at least one light source, toward at least the nickel sulfide based inclusion in the glass, through at least one window in a tempering chamber in which the glass is thermally tempered.

3. The method of claim 2, wherein the at least one window comprises a quartz window.

4. The method of claim 1, further comprising focusing the additional energy on at least an area of the glass including the nickel sulfide based inclusion.

5. The method of claim 1, wherein the additional energy comprises at least one wavelength in a range of from 300-1100 nm.

6. The method of claim 1, wherein the additional energy comprises at least one wavelength in a range of from 380-700 nm.

7. The method of claim 1, wherein the additional energy comprises a plurality of wavelengths in a range of from 300-1100 nm.

8. The method of claim 1, wherein the additional energy is directed toward at least the inclusion during at least a majority of the rapidly cooling process.

9. The method of claim 1, wherein the additional energy is provided in an amount sufficient to: (i) prevent at least one nickel sulfide based inclusion in the glass from being trapped in the alpha-phase in a final glass product, and (ii) allow the nickel sulfide based inclusion in the alpha-phase to relax to the relatively harmless beta-phase within 24 hours of the end of the application of forced cold air, so that the inclusion in the final glass product is in the beta-phase.

10. The method of claim 1, wherein the additional energy is directed across the entirety, or across substantially the entirety, of a dimension of the glass.

11. The method of claim 10, wherein said dimension is a width of the glass as viewed from above.

12. The method of claim 10, wherein, when the additional energy is directed toward the glass, location(s) of nickel sulfide based inclusion(s) is/are not known and/or it is not known whether nickel sulfide based inclusion(s) is/are present in the glass toward which the additional energy is directed.

13. The method of claim 1, wherein the additional energy is directed only toward areas of the glass where nickel sulfide based inclusions are believed to be present.

14. A method of making thermally tempered glass, the method comprising:
thermally tempering glass including a base glass composition comprising:

| Ingredient | wt. % |
|---|---|
| SiO₂ | 67-75% |
| Na₂O | 10-20% |
| CaO | 5-15% |
| A1₂O₃ | 0-7% |
| K₂O | 0-7% |

wherein the thermally tempering comprises heating the glass to at least a softening temperature via temperature(s) of at least 580 degrees C., and then rapidly cooling the glass in a rapidly cooling process; and
during at least part of the rapidly cooling of the glass, directing additional energy toward at least a nickel sulfide based inclusion in the glass in order to slow down cooling of the nickel sulfide based inclusion, so as to allow the nickel sulfide based inclusion to transition safely from a high temperature alpha-phase to a beta-phase.

15. The method of claim 14, wherein the additional energy is directed from at least one light source, toward at least the nickel sulfide based inclusion in the glass, through at least one window in a tempering chamber in which the glass is thermally tempered.

16. The method of claim 15, wherein the at least one window comprises a quartz window.

17. The method of claim 14, further comprising focusing the additional energy on at least an area of the glass including the nickel sulfide based inclusion.

18. The method of claim 14, wherein the additional energy comprises at least one wavelength in a range of from 300-1100 nm.

19. The method of claim 14, wherein the additional energy is directed toward at the inclusion during at least a majority of the rapidly cooling process.

20. The method of claim 14, wherein the additional energy is provided in an amount sufficient to: (i) prevent at least one nickel sulfide based inclusion in the glass from being trapped in the alpha-phase in a final glass product, and (ii) allow the nickel sulfide based inclusion in the alpha-phase to relax to the relatively harmless beta-phase within 24 hours of the end of the application of forced cold air, so that the inclusion in the final glass product is in the beta-phase.

21. The method of claim 14, wherein the additional energy is directed across the entirety, or across substantially the entirety, of a dimension of the glass.

22. The method of claim 21, wherein said dimension is a width of the glass as viewed from above.

23. The method of claim 14, wherein, when the additional energy is directed toward the glass, location(s) of nickel sulfide based inclusion(s) is/are not known and/or it is not known whether nickel sulfide based inclusion(s) is/are present in the glass toward which the additional energy is directed.

24. The method of claim 14, wherein the additional energy is directed only toward areas of the glass where nickel sulfide based inclusions are believed to be present.

25. A system for thermally tempering glass in order to reduce glass failures from nickel sulfide based inclusions, the system comprising:
a chamber configured for thermally tempering glass including a base glass composition comprising:

| Ingredient | wt. % |
|---|---|
| SiO₂ | 67-75% |
| Na₂O | 10-20% |
| CaO | 5-15% |
| A1₂O₃ | 0-7% |
| K₂O | 0-7% |

at least one heat source configured to heat the glass in the chamber to at least a softening temperature via temperature(s) of at least 580 degrees C.,
at least one cooling port configured for rapidly cooling the glass via forced cold air; and
at least one processor configured to, during at least part of the rapidly cooling, control at least one energy source to direct additional energy toward at least a nickel sulfide based inclusion in the glass in order to slow down cooling of the inclusion, relative to another area of the glass, so as to allow the nickel sulfide based inclusion to transition safely from a high temperature alpha-phase to a beta-phase.

26. The system of claim 25, wherein the additional energy is directed from the at least one energy source, toward at least the nickel sulfide based inclusion in the glass, through at least one window in the chamber.

27. The system of claim 26, wherein the at least one window comprises a quartz window.

28. The system of claim 25, wherein the additional energy comprises at least one wavelength in a range of from 300-1100 nm.

29. The system of claim 25, wherein the at least one processor is configured to cause the additional energy to be directed toward at least the inclusion during at least a majority of the rapidly cooling.

30. The system of claim 25, wherein the at least one light source and/or processor is/are configured to provide the additional energy in an amount sufficient to: (i) prevent at least one nickel sulfide based inclusion in the glass from being trapped in the alpha-phase in a final glass product, and (ii) allow the nickel sulfide based inclusion in the alpha-phase to relax to the relatively harmless beta-phase within 24 hours of the end of the application of forced cold air, so that the inclusion in the final glass product is in the beta-phase.

31. The system of claim 25, wherein the at least one light source and/or processor is/are configured to direct the additional energy across the entirety, or across substantially the entirety, of a dimension of the glass.

32. The system of claim 31, wherein said dimension is a width of the glass as viewed from above.

33. A system for processing glass in order to reduce glass failures from nickel sulfide based inclusions, the system comprising:
a chamber configured for heating glass including a base glass composition comprising:

| Ingredient | wt. % |
|---|---|
| SiO₂ | 67-75% |
| Na₂O | 10-20% |
| CaO | 5-15% |
| A1₂O₃ | 0-7% |
| K₂O | 0-7% |

at least one heat source configured to heat the glass in the chamber to at least a softening temperature via temperature(s) of at least 580 degrees C.,
at least one cooling port configured for cooling the glass; and
at least one processor configured to, during at least part of the cooling, control at least one energy source to direct additional energy toward the glass in order to slow down cooling of an inclusion, relative to another area of the glass, so as to allow the inclusion to transition safely from a first phase to a second phase.

34. The system of claim 33, wherein the additional energy is directed from the at least one energy source, toward at least the inclusion in the glass, through at least one window in the chamber.

35. The system of claim 33, wherein the additional energy comprises at least one wavelength in a range of from 300-1100 nm.

36. The system of claim 33, wherein the at least one processor is configured to cause the additional energy to be directed toward the glass during at least a majority of the rapidly cooling.
